(19) United States
(12) Patent Application Publication
(10) Pub. No.: US 2022/0342636 A1
(43) Pub. Date: Oct. 27, 2022

(54) System and Method for Calculating Rentable Building Area

(71) Applicant: Terry Torres, San Fernando, CA (US)

(72) Inventor: Terry Torres, San Fernando, CA (US)

(21) Appl. No.: 17/721,876

(22) Filed: Apr. 15, 2022

Related U.S. Application Data
(60) Provisional application No. 63/179,618, filed on Apr. 26, 2021.

(51) Int. Cl. G06F 7/544

(52) U.S. Cl. CPC G06F 7/544

(57) ABSTRACT

A system and method for calculating rentable building area is provided. The system includes a device having a non-transitory computer readable memory and a processor, wherein the device is in wireless communication with a remote database. The non-transitory computer readable memory includes a software application thereon, wherein the software application calculates a building load factor and a rentable building area of individual rental spaces within a desired building via a plurality of user-specified building parameters. The plurality of user-specified building parameters includes at least a gross building area and a usable building area, wherein the building load factor is calculated via the gross building area and the total usable building area. The rentable building area is then calculated via the usable building area of the individual rental space and the building load factor and displayed on a display of the device.

### CROSS REFERENCE TO RELATED APPLICATIONS

This application claims the benefit of U.S. Provisional Application No. 63/179,618 filed on Apr. 26, 2021. The above identified patent application is herein incorporated by reference in its entirety to provide continuity of disclosure.

### BACKGROUND OF THE INVENTION

The present invention relates to systems for calculating rentable building area. More particularly, the present invention pertains to a system capable of cataloguing and remotely storing load factors and rentable building areas for multiple individual rental spaces within a variety of buildings.

Many property owners and potential renters have difficulty determining ideal rental rates for an individual rental space. Several factors come into play when determining how much a particular rental space should cost to rent, including the total usable area of the rental space, as well as upkeep and benefit gained from any common areas that the renter of the individual rental space would also have access to, such as building-wide amenities, hallways, maintenance/utility access, storage, bathrooms, or the like. In order to determine what proportion of these common areas a renter should be responsible for a building load factor is commonly used. The building load factor is typically a method of dividing the cost of maintenance and upkeep of the common areas between all potential renters within the building by effectively scaling the rented area to incorporate a portion of the common area, referred to as a rentable building area. However, in certain cases, typical building load factor may be inappropriate, as it fails to account for limited common areas that only some of the rental spaces have access to. For example, increasing the rent of one rental space to account for a shared bathroom accessible by only two other adjacent rental spaces is inappropriate. Therefore, a more granular approach to calculating the rentable building area for each individual rental space is desired.

Additionally, keeping track of the rentable building area of each individual rental space within multiple buildings can be difficult. Should a renter wish to compare the costs and amenities offered by similar rental spaces in different buildings, keeping a record of each building and rental space is necessary. Furthermore, a property owner may wish to keep a record of the building load factor and rentable building area for each rental space in any buildings they control. Therefore, an application that can calculate, display, and store the rentable building area and associated building load factor of each rental space within a variety of buildings on each of an overall building, floor-by-floor, and individual rental space paradigm is desired.

In light of the devices disclosed in the known art, it is submitted that the present invention substantially diverges in design elements from the known art and consequently it is clear that there is a need in the art for an improvement to existing systems for calculating rentable building area. In this regard, the instant invention substantially fulfills these needs.

### SUMMARY OF THE INVENTION

In view of the foregoing disadvantages inherent in the known types of systems of calculating rentable building area now present in the known art, the present invention provides a system for calculating rentable building area wherein the same can be utilized for providing convenience for the user when evaluating multiple individual rental spaces within various existing buildings to determine the ideal rental space incorporating available amenities.

The present system comprises a device having a non-transitory computer readable memory and a processor, wherein the device is in wireless communication with a remote database. The non-transitory computer readable memory includes a software application thereon, the software application configured to calculate a building load factor and a rentable building area of individual rental spaces within a desired building via a plurality of user-specified building parameters. The plurality of user-specified building parameters includes at least a gross building area and a usable building area, such that the following calculations are based on an overall building paradigm. In some embodiments, the user-specified building parameters includes one or more common groups, wherein each common group contains one or more user-designated common space areas. Each common group can then be assigned to each individual rental space via the software application, such that the load factors can be calculated for each individual rental space to account for limited common areas shared with only a subset of the individual rental spaces within the desired building. The building load factor is then calculated via the gross building area and the usable building area, including common groups where appropriate. The rentable building area is then calculated using the usable building area of the individual rental space and the building load factor. Each of the building load factor and the rental building area can then be displayed on a display of the device.

In some embodiments, the plurality of user-specified parameters further includes a building vertical shaft area, wherein the gross building area is further modified via deducting the building vertical shaft area. In another embodiment, the software application further calculates and displays an overall building common space area via deducting the total usable building area from the gross building area. In other embodiments, the software application further subdivides the desired building into a plurality of individual floors, wherein the building load factor and rentable building area is calculated for each individual floor of the plurality of individual floors. In yet another embodiment, the software application further calculates an overall building load factor via the gross building area of each floor of the plurality of individual floors and the usable building area of each floor of the plurality of individual floors. In some embodiments, the software application further creates a user profile, wherein the user profile stores the plurality of user-specified parameters and the calculated rentable building area and the calculated building load factor for a plurality of individual buildings. In other embodiments, the user profile and associated stored data is further transmitted to and stored on the remote database.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a flowchart of the system for calculating rentable building area.

FIG. 2 shows a flowchart of an alternate embodiment of the system for calculating rentable building area incorporating limited access common areas.

FIG. 3 shows a plan view of a floorplan of an exemplary building area.

### DETAILED DESCRIPTION OF THE INVENTION

Reference is made herein to the attached drawings. Like reference numerals are used throughout the drawings to depict like or similar elements of the system for calculating rentable building area. The figures are intended for representative purposes only and should not be considered to be limiting in any respect.

According to some embodiments, the operations, techniques, and/or components described herein can be implemented as (i) a special-purpose computing device having specialized hardware and a logic hardwired into the computing device to persistently perform the disclosed operations and/or techniques or (ii) a logic that is implementable on an electronic device having a general purpose hardware processor to execute the logic and a computer-readable medium, e.g. a memory, wherein implementation of the logic by the processor on the electronic device provides the electronic device with the function of a special-purpose computing device.

In the interests of economy, the present disclosure refers to “a computer-readable medium,” “a processor,” and so on. However, this should not be read as limiting in any way as the present disclosure contemplates embodiments of the present invention utilizing “one or more computer-readable media,” “one or more processors,” and so on. Unless specifically limited to a single unit, “a” is intended to be equivalent to “one or more” throughout the present disclosure.

As referred to herein, the term “electronic device” refers to any computing device that includes at least a display screen and an input mechanism. The computing devices can be hard-wired to perform the operations, techniques, and/or components described herein, or can include digital electronic devices such as one or more application-specific integrated circuits (ASICs) or field programmable gate arrays (FPGAs) that are persistently programmed to perform the operations, techniques and/or components described herein, or can include one or more general purpose hardware processors programmed to perform such features of the present disclosure pursuant to program instructions in firmware, memory, other storage, or a combination. Such computing devices can also combine custom hard-wired logic, ASICs, or FPGAs with custom programming to accomplish the technique and other features of the present disclosure. The computing devices can be desktop computer systems, laptops, cell phones, tablets, networking devices, or any other device that incorporates hard-wired and/or program logic to implement the techniques and other features of the present disclosure.

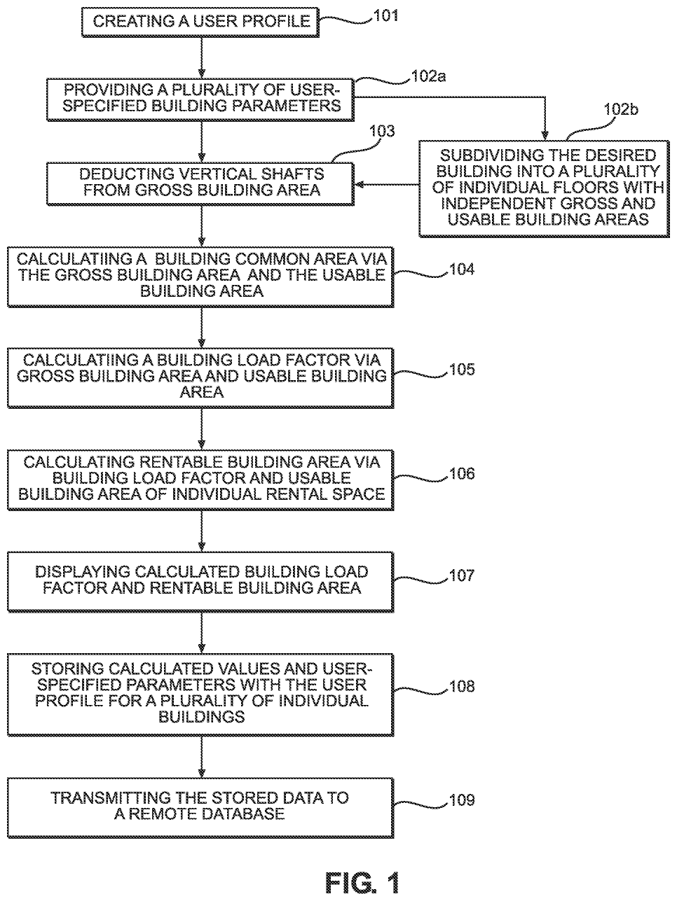

Referring now to FIG. 1, there is shown a flowchart of the system for calculating rentable building area. The system for calculating rentable building area comprises a device having a non-transitory computer readable memory and a processor, wherein the device is in wireless communication with a remote database. The device is contemplated to comprise a variety of electronic devices as highlighted above, including, but not limited to, smartphones, tablets, desktop computers, or the like. The non-transitory computer readable memory includes a software application thereon, whereupon execution of by the processor, the software application is configured to calculate at least a building load factor and a rentable building area for individual rental spaces within a desired building via a plurality of user-specified building parameters. These user-specified building parameters, calculated building load factors and rentable building areas, and the like can then be transmitted to and stored on the remote database. The software application is further contemplated to comprise a user interface including various controls and displays for inputting the plurality of user-specified building parameters and displaying the calculated values, as well as the ability to assign each parameter to a particular individual rental space within a desired building. In this manner, the user can determine the approximate effective area of a rentable space that is incorporated into the total rent for the space (hereinafter “rentable building area”). For example, in buildings having greater availability of amenities, an individual rental space may be required to pay more in rent than an equivalent rental space in a different building with fewer amenities. As such, a potential renter or property owner can better ascertain what effective area an individual rental space should be used for the purposes of calculating rent. The individual rental spaces are contemplated to include suites of offices, floors, individual offices, or other subdivisions of a building to be rented to an individual or business. When contemplating the rentable building area of each of these individual rental spaces, the actual area of the rental space (hereinafter “usable building area”) is scaled to account for a portion of shared amenities within the building, such as public restrooms, hallways, storage rooms, electrical closets, lobbies, concession areas, or the like.

In the shown embodiment, the process includes creating a user profile 101 that is used to store and catalogue multiple rental spaces within one or more desired buildings for later reference and comparison. The user can then select a particular building and provide a plurality of user-specified building parameters 102a for the desired building. The plurality of user-specified building parameters includes at least a gross building area incorporating a total area of the building and a usable building area. The usable building area includes a combined total of the actual area of each rentable space in combination. In some embodiments, the software application can then be used to subdivide the desired building into a plurality of individual floors 102b, such that rather than calculating the overall building load factor, the user can calculate the load factors and associated rentable building area on a floor-by-floor basis. In this manner, amenities, and other common areas on floors where the individual rental space does not have access is not incorporated into the load factor and rentable building area for the individual rental space. In such multi-story calculations, the user can further include ground floor common areas, such as lobbies, concessions, or the like, in the calculations for each individual floor of the desired building, to accurately represent the available amenities the individual floors have access to. Once the gross building area is determined, in some embodiments, the user can further modify the gross building area by deducting the area of any vertical shafts 103, such as elevators and stairwells, from the gross building area, as many jurisdictions require that vertical shaft areas not be included in determinations of rental costs. In some embodiments, the software application then calculates and displays the building common area 104 by deducting the total usable building area from the gross building area, as any remaining area not within the accumulated area of the rental spaces must be a shared or common area. This common area can be used to quickly visualize the proportion of building area that may be incorporated into the determination of rental costs for the individual rental space relative to the size of the particular individual rental space. The software application further calculates the building load factor using the gross building area and the usable building area 105. The building load factor is determined by dividing the gross building area by the total usable building area within the desired building. For the purposes of this calculation, the gross building area can further comprise the modified gross building area to account for the deduction of vertical shaft spaces. In this manner, the building load factor comprises a proportion of the building that is considered a common area. Once the building load factor is calculated, the software application then calculates the rentable building area of the individual rentable space 106 via multiplying the usable area of the individual rental space by the building load factor. As such, the user is provided a scaled area upon which rent can be determined. For the purposes of illustration, a desired building may have a gross building area of 100,000 sq. ft. and a total usable area of 90,000 sq. ft., leaving 10,000 sq. ft. as common areas. For an individual rental space of 5,000 sq. ft., the rentable building area would be scaled up by the building load factor of 100,000/90,000 or 1.11, leading to a rentable building area of 5,555.56 sq. ft. Therefore, a renter would be charged as if the individual rental space had the area of the rentable building area. Once calculated, in the illustrated embodiment, the building load factor and the rentable building area would be displayed 107 for user review and reference. These values and the plurality of user-specified parameters would then be stored 108 within the user profile as previously described and transmitted 109 to the remote database for storage.

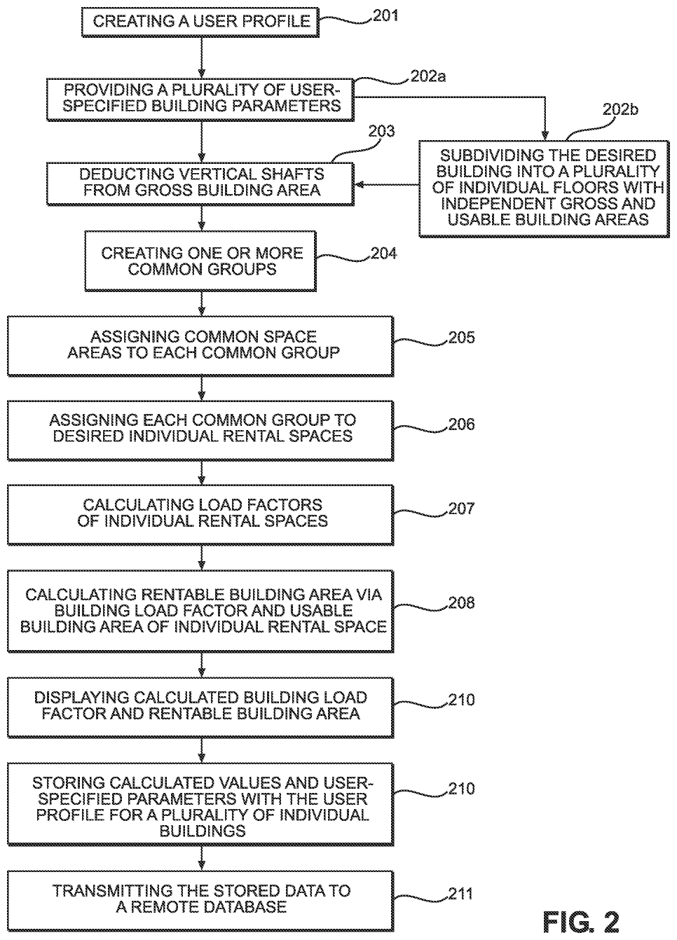

Referring now to FIG. 2, there is shown a flowchart of an alternate embodiment of the system for calculating rentable building area incorporating limited access common areas. In the shown embodiment, the software application further accounts for limited common areas accessible by only some of the individual rental spaces, such as shared restrooms or storage between adjacent rental suites or the like. As incorporating these limited common areas into the determination of building load factors for individual rental spaces that do not have access to the limited common areas would be inappropriate, the software application further allows the common areas of a desired building to be divided into common groups, which can then be assigned to each individual rental space based on access to the common areas within the group. These common groups can be deducted from the gross building area when determining the building load factor of a particular rental space without access to the common areas within the common group. In this manner, when determining the building load factor for the desired individual rental space, the common groups unassociated with the rental space are ignored, and each individual rental space pays a scaled rent based upon access to common areas.

Similar to as previously described, the process includes creating a user profile 201 that is used to store and catalogue multiple rental spaces within one or more desired buildings for later reference and comparison. The user can then select a particular building and provide a plurality of user-specified building parameters 202a for the desired building. The plurality of user-specified building parameters includes at least a gross building area incorporating a total area of the building and a usable building area. The usable building area includes a combined total of the actual area of each rentable space in combination. In some embodiments, the software application can then be used to subdivide the desired building into a plurality of individual floors 202b, such that rather than calculating the overall building load factor, the user can calculate the load factors and associated rentable building area on a floor-by-floor basis. In this manner, amenities, and other common areas on floors where the individual rental space does not have access is not incorporated into the load factor and rentable building area for the individual rental space. In such multi-story calculations, the user can further include ground floor common areas, such as lobbies, concessions, or the like, in the calculations for each individual floor of the desired building, to accurately represent the available amenities each of the individual floors have access to. Once the gross building area is determined, in some embodiments, the user can further modify the gross building area by deducting the area of any vertical shafts 203, such as elevators and stairwells, from the gross building area, as many jurisdictions require that vertical shaft areas not be included in determinations of rental costs. In the illustrated embodiment, the user can create one or more common groups 204, each representing a portion of the total building common areas that a subset of the individual rental spaces have access to. The user can then assign the common spaces to each common group 205, which can then be assigned to each individual rental space 206. For example, two suites may share a restroom or storage area that does not benefit a third suite. In such scenarios, the user can assign the shared space to a common group, which can then be assigned to each of the two suites that have access to the shared space. In this manner, when the building load factor is calculated 207, only the common areas that the individual rental spaces has access to are included in the modified gross building area. Therefore, in such embodiments, the building load factor is determined by dividing the gross building area by the total usable building area within the desired building. For the purposes of this calculation, the gross building area can further comprise the modified gross building area to account for the deduction of vertical shaft spaces and unaffiliated common groups. In this manner, the building load factor comprises a proportion of the building that is considered a common area that the particular individual rental space has access to. Once the appropriate building load factor for the individual rental space is calculated, the software application then calculates the rentable building area of the individual rentable space 208 via multiplying the usable area of the individual rental space by the appropriate building load factor. As such, the user is provided a scaled area upon which rent can be determined. For the purposes of illustration, a desired building may have a gross building area of 100,000 sq. ft. and a total usable area of 90,000 sq. ft., leaving 10,000 sq. ft. as common areas. However, 2,000 sq. ft. of these common areas may only be accessible by other rentable spaces within the building, such that including that portion of the common areas for the current rental space would be inappropriate, leading to a modified gross building area of 98,000 sq. ft. For an individual rental space of 5,000 sq. ft., the rentable building area would be scaled up by the building load factor of 98,000/90,000 or 1.089, leading to a rentable building area of 5,444.44 sq. ft.

Therefore, a renter would be charged as if the individual rental space had the area of the rentable building area. Once calculated, in the illustrated embodiment, the building load factor and the rentable building area would be displayed 209 for user review and reference. These values and the plurality of user-specified parameters would then be stored 210 within the user profile as previously described and transmitted 211 to the remote database for storage.

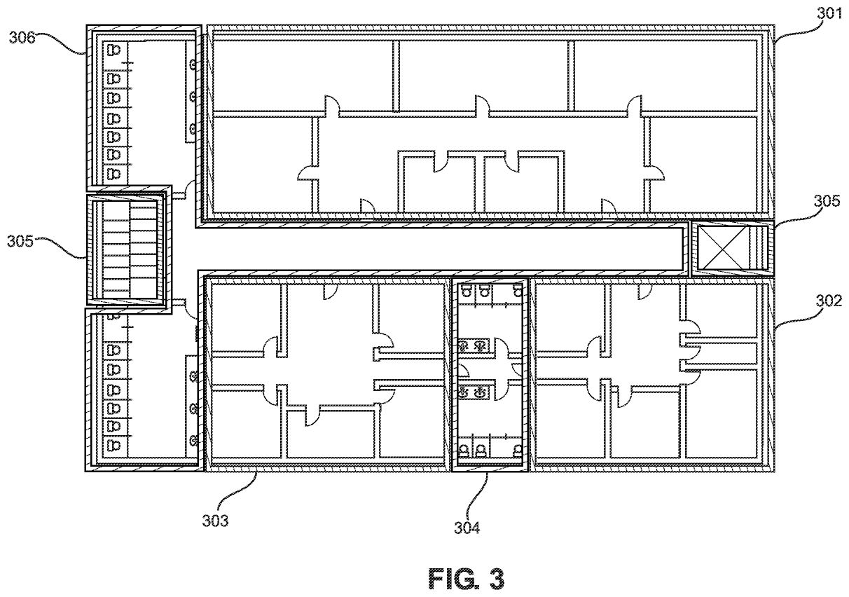

Referring now to FIG. 3, there is shown a plan view of a floorplan of an exemplary building area. In the shown embodiment, a floorplan of an exemplary building is provided to better illustrate the system and method of calculating rentable building area. In the shown embodiment, three individual rental spaces are shown, a first suite 301, a second suite 302, and a third suite 303. The second and third suites 302, 303 share a limited common space 304, while each of the first, second, and third suites 301, 302, 303 share common area 306, which includes a central hallway and a pair of public restrooms. Finally, a stairwell and elevator comprise vertical shafts 305 that must be deducted from the overall gross building area, as vertical shafts 305 cannot be included in determinations of rent. In the shown embodiment, in a user may select to calculate the rentable building area of the first suite 301, at which point the user must input the gross building area and the overall usable building area. The overall usable building area in the illustrated embodiment comprises the combined area of the first, second, and third suites 301, 302, 303. The user can then define a pair of common groups, each incorporating common area 306 and limited common space 304, respectively. Once created and defined, the common group associated with the common area 306 can be assigned to the first suite 301. The software application can then calculate the building load factor relative to the first suite 301 via dividing the modified gross building area by the overall usable building area. In the shown example, the modified gross building area relative to the first suite comprises the overall gross building area less the area of each vertical shaft 305 and the limited common space 304. This calculated building load factor, relative to the first suite 301, would then be multiplied by the usable building area of the first suite 301 to find the rentable building area for the first suite 301. Once complete, the calculated values are displayed on the device and further transmitted to the remote database and associated with the created user profile for storage. The same calculation can then be performed relative to each of the second and third suite 302, 303, however, in such calculations, the limited common space 304 would not be deducted from the overall gross building area, as each of the second and third suites 302, 303 benefit from the limited common space 304. In this manner, the user can ascertain the ideal rental opportunity from a consumer perspective, or alternatively, manage, review, and maximize potential rental income from a variety of properties from a property owner perspective.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly, and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A system for calculating rentable building area, comprising:
a device having a non-transitory computer readable memory and a processor;
wherein the device is in wireless communication with a remote database;
wherein the non-transitory computer readable memory includes a software application thereon, the software application configured to calculate a building load factor and a rentable building area of individual rental spaces within a desired building via a plurality of user-specified building parameters;
wherein the plurality of user-specified building parameters includes at least a gross building area and a usable building area;
wherein the building load factor is calculated via the gross building area and the usable building area;
wherein the rentable building area is calculated via the usable building area of the individual rental space and the building load factor;
whereupon calculating the building load factor and the rentable building area, the software application displays the calculated results on a display of the device.

2. The system of claim 1, wherein the plurality of user-specified parameters further include a building vertical shaft area, wherein the gross building area is further modified via deducting the building vertical shaft area.

3. The system of claim 1, wherein the software application further calculates and displays a building common space area via deducting the total usable building area from the gross building area.

4. The system of claim 1, wherein the software application further subdivides the desired building into a plurality of individual floors, wherein the building load factor and rentable building area is calculated for each individual floor of the plurality of individual floors.

5. The system of claim 4, wherein the software application further calculates an overall building load factor via the gross building area of each floor of the plurality of individual floors and the usable building area of each floor of the plurality of individual floors.

6. The system of claim 1, wherein the software application further creates a user profile, wherein the user profile stores the plurality of user-specified parameters and the calculated rentable building area and the calculated building load factor for a plurality of individual buildings.

7. The system of claim 6, wherein the user profile and associated stored data is further transmitted to and stored on the remote database.

8. A system for calculating rentable building area, comprising:
a device having a non-transitory computer readable memory and a processor;
wherein the device is in wireless communication with a remote database;
wherein the non-transitory computer readable memory includes a software application thereon, the software application configured to calculate a building load factor and a rentable building area of individual rental spaces within a desired building via a plurality of user-specified building parameters;
wherein the plurality of user-specified building parameters includes at least a gross building area, a usable building area, and one or more common groups;
wherein each of the one or more common groups include one or more user-designated common space areas;
wherein the one or more common groups can be assigned to each individual rental space via the software application;
wherein the building load factor of each individual rental space is calculated via the gross building area including the assigned common groups and the usable building area;
wherein the rentable building area is calculated via the usable building area of the individual rental space and the building load factor;
whereupon calculating the building load factor and the rentable building area, the software application displays the calculated results on a display of the device.

9. The system of claim 8, wherein the plurality of user-specified parameters further include a building vertical shaft area, wherein the gross building area is further modified via deducting the building vertical shaft area.

10. The system of claim 8, wherein the software application further subdivides the desired building into a plurality of individual floors, wherein the building load factor and rentable building area is calculated for each individual floor of the plurality of individual floors.

11. The system of claim 10, wherein the software application further calculates an overall building load factor via the gross building area of each floor of the plurality of individual floors and the usable building area of each floor of the plurality of individual floors.

12. The system of claim 1, wherein the software application further creates a user profile, wherein the user profile stores the plurality of user-specified parameters and the calculated rentable building area and the calculated building load factor for a plurality of individual buildings.

13. The system of claim 12, wherein the user profile and associated stored data is further transmitted to and stored on the remote database.

14. A non-transitory computer readable memory on which a software application is installed which, when executed by a processor, performs the following steps:
receiving a plurality of user-specified building parameters including at least a gross building area and a usable building area of a desired building;
calculating a building load factor via the gross building area and the usable building area;
calculating a rentable building area via the usable building area of an individual rental space and the building load factor;
displaying the calculated rentable building area and the building load factor.

15. The system of claim 14, further comprising assigning one or more common space areas to one or more common groups.

16. The system of claim 15, further comprising assigning one or more common groups to each individual rental space.

17. The system of claim 14, further comprising subdividing the desired building into a plurality of individual floors and calculating a building load factor and a rentable building area for each floor of the plurality of individual floors.

18. The system of claim 14, further comprising deducting a vertical shaft area from the gross building area to determine a modified gross building area to be utilized in the calculation of the building load factor.

19. The system of claim 14, further comprising creating a user profile and storing the plurality of user-specified parameters and the calculated building load factor and rentable building area for a plurality of individual buildings.
